(19) United States
(12) Patent Application Publication
(10) Pub. No.: US 2004/0170737 A1
(43) Pub. Date: Sep. 2, 2004

(54) Method for preparing a yellow pastry cake

(76) Inventor: Patrick Cavroy, Paris (FR)

Correspondence Address: YOUNG & THOMPSON, 745 SOUTH 23RD STREET 2ND FLOOR, ARLINGTON, VA, 22202

(21) Appl. No.: 10/479,610

(22) PCT Filed: Jun. 4, 2002
(86) PCT No.: PCT/FR02/01884

(30) Foreign Application Priority Data
Jun. 6, 2001 (FR) 01/07377

(51) Int. Cl. A21D 10/00

(52) U.S. Cl. 426/549

(57) ABSTRACT

The invention concerns a method for preparing a yellow pastry cake which comprises a first step which consists in mixing together eggs, sugar, part of the flour ad other secondary ingredients (such as salt), then a second step which consists in adding, preferably without mixing, the rest of the flour, yeast and other optional ingredients such as flavouring agents.

The present invention relates to a novel method for preparing a sponge cake, in particular genoese sponges.

Research into recipes for cakes which have a good final development is always being carried out.

Moreover, to the extent that eggs are expensive, efforts are being made to replace them, in particular in industrial recipes. Moreover, dieticians and vegans need cakes without eggs.

The traditional method of making a genoese sponge consisted of beating together the eggs, sugar and other secondary ingredients (such as salt), then adding, without beating, the flour, yeast and a few other ingredients (flavourings etc.). This method is still used by artisans and cooks.

Today, industrially, all the ingredients are generally put together and beaten in the presence of an emulsifier.

After long research, the Applicant has discovered that in the recipe for industrial preparation of a sponge cake, by operating in two stages and incorporating the flour in two parts, a first part during the beating and a second part after the beating, a cake which has a good final development is obtained.

A subject of the present Application is therefore a process for preparing a sponge cake characterized in that eggs, sugar, part of the flour and other secondary ingredients (such as salt) are beaten together (first stage), then the rest of the flour, yeast and other optional ingredients such as flavourings are added, preferably without beating (second stage). The preparation obtained can then be placed in a mould and put in the oven.

In the case of madeleines, fruit cakes and brioches, the first stage can involve not beating, but rapid, thorough mixing; the second stage in all cases involves only homogeneous addition of the rest of the flour to the dough obtained during the first mixing or beating.

In the case of use of an emulsifier, this is added during the first stage.

In the present Application, and in the following, the term “sponge cake” designates for example a fruit cake, genoese layers, Savoy sponge cake, choux pastries, gingerbread, cake bars (copies of pound cake), pannetones, Kouglofs, in particular a madeleine, brioche, roulade, and preferably a genoese sponge.

It is possible to use for example 3% to 80%, preferably 10% to 70%, particularly 20% to 60%, of the flour during the beating stage and the rest during the second stage.

In the present Application and in the following, the percentages indicated refer to weight.

When it is stated that the rest of the flour, yeast and other optional ingredients are added “without beating”, this means simply doing what is necessary to add the flour to the dough with a view to obtaining a homogeneous mixture, or simply beating lightly.

However, the first stage usually makes it possible to obtain a dough which is sufficiently firm that, whatever the mixing method of the second stage, with or without beating, the dough does not collapse during the mixing.

In addition, the recipes for certain above-mentioned sponge cakes, such as a fruit cake, Madeleine, brioche, require fat. This can be introduced in the first stage or the second stage, or partly in the first stage and partly in the second stage. A person skilled in the art knows when to introduce the optional ingredients: candied fruit, etc.

During its research, the Applicant also realized that it was moreover possible to replace a large proportion of the eggs with an egg substitute while still obtaining good results.

A subject of the present Application is therefore also a process for preparing a sponge cake characterized in that part of the quantity of eggs necessary is replaced by an egg substitute.

The term “egg substitute” designates a high-protein mixture of food products which display, in combination with eggs, a behaviour during beating and in the oven comparable to that of real eggs. The egg substitute marketed by the company FOCO (Paris—France) under the name DINALPLUS-1®, or that marketed under the name OVALVA®, and preferably the substitute, the composition of which is given below in the experimental part, marketed by the company SRGP-FOCO (INDE) under the name DINALPLUS®, can for example be mentioned.

Under preferential conditions for the implementation of the above-mentioned process, for example 20% to 70%, preferably 30% to 60%, particularly 40% to 60% of the eggs necessary for the standard recipe, i.e. without partial or total egg substitution, are replaced.

In further pursuit of its research, the Applicant also realized that moreover all of the eggs were able to be replaced by an egg substitute while still obtaining good results, as long as part of the egg substitute was added during the first stage and the rest during the second stage.

A further subject of the present Application is therefore an above-mentioned process characterized in that all of the eggs are replaced by an egg substitute and that part of the egg substitute is added during the first stage and the rest during the second stage.

For example, 10% to 80%, preferably 20% to 70%, particularly 30% to 70% of the egg substitute can be introduced during the first stage and the rest during the second stage.

Furthermore, the Applicant realized that moreover certain components of the egg substitute were able to be added during the first stage and the rest of the components during the second stage while still obtaining good results.

Finally, a subject of the present Application is an above-mentioned process characterized in that certain components of the egg substitute are added during the first stage and the rest of the components during the second stage.

An egg substitute is generally composed of protein products, some of which do not hinder development when beaten, such as lactalbumin or whey. The latter can preferentially be introduced during the first phase, during beating, and the others such as pea or rice flour with the rest of the flour during the second phase. This makes it possible to add more low-cost proteins (the protein is all the more low-cost, when it is added in the form of a less protein-rich compound).

The following examples illustrate the present Application.

Production Process 1: Preparation of Genoese Sponges of the Prior Art

Industrial genoese sponges of the prior art were prepared with the composition and method described below:

Beat together with an egg beater:

| | |
|---|---|
| Sugar | 250 g |
| Flour | 250 g |
| Eggs | 330 g |
| Emulsifier (mono and diglycerides | 10 g |
| of fatty acids and lecithins) | |
| Salt | A pinch |
| Yeast | 5 g |

Place in moulds, then in the oven at 180° C. for 25 minutes.

Well-developed genoese sponges are obtained, with a soft crumb.

### EXAMPLE 1

### Preparation of Reference Genoese Sponges

Genoese sponges with eggs were prepared with the composition and method described below.

Stage 1: Beat together with an egg beater until a homogenous aerated dough is obtained:

| | |
|---|---|
| Sugar | 250 g |
| Flour | 125 g |
| Eggs | 330 g |
| Emulsifier (mono and diglycerides | 10 g |
| of fatty acids and lecithins) | |
| Salt | A pinch |

Stage 2: Add to the composition obtained in the first stage, by simple mixing:

| | |
|---|---|
| Yeast | 5 g |
| Flour | 125 g |

Place in moulds, then in the oven at 180° C. for 25 minutes.

Genoese sponges are obtained, the development of which is very superior to that of production process 1.

This significant improvement allows the use of a large proportion of egg substitutes.

### EXAMPLE 2

### Preparation of Genoese Sponges

Genoese sponges with eggs were prepared with the composition and method described below.

Stage 1: Beat together with an egg beater until a homogenous aerated dough is obtained:

| | |
|---|---|
| Sugar | 250 g |
| Flour | 125 g |
| Eggs | 132 g |
| Preparation A | 39.6 g |
| Water | 158.4 g |
| Emulsifier (mono and diglycerides | 10 g |
| of fatty acids and lecithins) | |
| Salt | A pinch |

Stage 2: Add to the composition obtained in the first stage, by simple mixing

| | |
|---|---|
| Yeast | 5 g |
| Flour | 125 g |

Place in moulds, then in the oven at 180° C. for 25 minutes.

Genoese sponges are obtained, the development of which is superior to that of production process 1, while having saved 60% of the eggs necessary for the standard recipe (without partial or total egg substitution).

Preparation A is a partial egg substitute, composed of ground

| | |
|---|---|
| Pea flour | 48% |
| Rice flour | 32% |
| Maize starch | 13% |
| Albumin (70% protein) | 7% |

marketed by the company SRGP-FOCO (INDE) under the name DINALPLUS®.

### EXAMPLE 3

### Preparation of Genoese Sponges

Genoese sponges without eggs were prepared with the composition and method described below.

Stage 1: Beat together with an egg beater until a homogenous aerated dough is obtained:

| | |
|---|---|
| Sugar | 217 g |
| Flour | 125 g |
| Preparation A | 44 g |
| Water | 264 g |
| Emulsifier (mono and diglycerides | 15 g |
| of fatty acids and lecithins) | |
| Salt | A pinch |

Stage 2: Add to the composition obtained in the first stage, by simple mixing

| | |
|---|---|
| Yeast | 5 g |
| Preparation A | 88 g |
| Water | 92 g |

Place in moulds, then in the oven at 180° C. for 25 minutes.

Genoese sponges are obtained, the development of which is superior to that of production process 1, while having saved 100% of the eggs necessary for the standard recipe (without partial or total egg substitution).

### EXAMPLE 4

### Preparation of Genoese Sponges

Genoese sponges without eggs were prepared with the composition and method described below.

Stage 1: Beat together with an egg beater until a homogenous aerated dough is obtained:

| | |
|---|---|
| Sugar | 225 g |
| Flour | 125 g |
| Preparation B in part | 66 g |
| (Albumin 13.2 g + pea flour 52.8 g) | |
| Water | 264 g |
| Emulsifier (mono and diglycerides | 10 g |
| of fatty acids and lecithins) | |
| Salt | A pinch |

Stage 2: Add to the composition obtained in the first stage, by simple mixing

| | |
|---|---|
| Yeast | 5 g |
| Pea flour | 44 g |
| Flour | 125 g |

Place in moulds, then in the oven at 180° C. for 25 minutes.

Preparation B is a partial egg substitute composed of ground

| | |
|---|---|
| Pea flour | 87.5% |
| Albumin (70% protein) | 12.5% |

Genoese sponges are obtained, the development of which is superior to that of production process 1, while having saved 100% of the eggs necessary for the standard recipe (without partial or total egg substitution).

### EXAMPLE 5

### Preparation of Genoese Sponges

Genoese sponges without eggs were prepared with the composition and according to the method described below:

Stage 1: Beat together with an egg beater until a homogenous aerated dough is obtained:

| | |
|---|---|
| Crystallized sugar | 225 g |
| Flour | 125 g |
| 70% protein lactalbumin | 13.2 g |
| Water | 264 g |
| Emulsifier (mono and diglycerides | 10 g |
| of fatty acids and lecithins) | |
| Salt | A pinch |

Stage 2: Add to the composition obtained in the first stage, by simple mixing:

| | |
|---|---|
| Yeast | 2.5 g |
| Ovalplus-1 ® | 60 g |
| Flour | 125 g |

The ovalplus-1® is composed of:

| | |
|---|---|
| 70% protein lactalbumin | 8% |
| Pea flour | 62% |
| Rice flour | 14% |
| Potato starch | 16% |

The same tests were carried out without emulsifier with success, but a slightly poorer development.

In this case the flour is added in appreciably different proportions:

1st stage: approximately 15% of the flour,

2nd stage: approximately 85% of the flour.

The same tests were also carried out with an emulsifier constituted by mono and diglycerides in a glucose syrup support. Identical results were obtained.

1. A process for preparing a sponge cake characterized in that eggs, sugar, part of the flour and other secondary ingredients (such as salt) are beaten together (first stage), then the rest of the flour, yeast and other optional ingredients such as flavourings are added (secondary stage).

2. A process according to claim 1, characterized in that during the second stage, the rest of the flour, yeast and other optional ingredients such as flavourings are added, without beating.

3. A process according to one of claims 1 and 2, characterized in that 10% to 70% of the flour is introduced during the beating stage and the rest during the second stage.

4. A process according to one of claims 1 to 3, characterized in that 20% to 60% of the flour is introduced during the beating stage and the rest during the second stage.

5. A process according to one of claims 1 to 4, characterized in that part of the quantity of eggs necessary is replaced by an egg substitute.

6. A process according to one of claims 1 to 5, characterized in that 20% to 70% of the eggs necessary for the standard recipe are replaced (without partial or total egg substitution).

7. A process according to one of claims 1 to 6, characterized in that 30% to 60% of the eggs necessary for the standard recipe are replaced (without partial or total egg substitution).

8. A process according to one of claims 1 to 4, characterized in that all of the eggs necessary for the standard recipe are replaced (without partial or total egg substitution) by an egg substitute.

9. A process according to claim 8, characterized in that part of the said egg substitute is added during the first stage and the rest during the second stage.

10. A process according to claim 9, characterized in that 30% to 70% of the egg substitute is added during the beating stage and the rest during the second stage.

11. A process according to one of claims 1 to 4, characterized in that all of the eggs necessary for the standard recipe are replaced (without partial or total egg substitution) by an egg substitute and in that certain components of the said egg substitute are added during the first stage and the rest of the components during the second stage.

12. A process according to one of claims 1 to 11, characterized in that the sponge cake is a genoese sponge.
